(19) United States
(12) Patent Application Publication
(10) Pub. No.: US 2005/0063381 A1
(43) Pub. Date: Mar. 24, 2005

(54) Hardware acceleration for unified IPSec and L2TP with IPSec processing in a device that integrates wired and wireless LAN, L2 and L3 switching functionality

(76) Inventors: Mathew Kayalackakom, Cupertino, CA (US); Abhijit K. Choudhury, Cupertino, CA (US); Ken C. K. Chin, Saratoga, CA (US); Shekhar Ambe, San Jose, CA (US); Joseph J. Tardo, Palo Alto, CA (US)

Correspondence Address: Pillsbury Winthrop LLP, Suite 200, 11682 El Camino Real., San Diego, CA, 92130-2092, US

(21) Appl. No.: 10/884,392

(22) Filed: Jul. 2, 2004

Related U.S. Application Data
(60) Provisional application No. 60/484,993, filed on Jul. 3, 2003.

(51) Int. Cl. H04L 12/56

(52) U.S. Cl. 370/389

(57) ABSTRACT

An apparatus provides an integrated single chip solution to solve a multitude of WLAN problems, and especially Switching/Bridging, and Security. In accordance with an aspect of the invention, the apparatus is able to terminate secured tunneled IPSec and L2TP with IPSec traffic. In accordance with a further aspect of the invention, the architecture can handle both tunneled and non-tunneled traffic at line rate, and manage both types of traffic in a unified fashion. The architecture is such that it not only resolves the problems pertinent to WLAN, it is also scalable and useful for building a number of useful networking products that fulfill enterprise security and all possible combinations of wired and wireless networking needs.

### CROSS-REFERENCE TO RELATED APPLICATIONS

The present application claims priority to provisional application 60/484,993, filed on Jul. 3, 2003.

### FIELD OF THE INVENTION

Aspects of the present invention relate generally to network communications, and more particularly, to wired and wireless networks and architectures.

### BACKGROUND

The Wireless Local Area Network (WLAN) market has recently experienced rapid growth, primarily driven by consumer demand for home networking. The next phase of the growth will likely come from the commercial segment such as enterprises, service provider networks in public places (Hotspots), multi-tenant, multi-dwelling units (MxUs) and small office home office (SOHOs). The worldwide market for the commercial segment is expected to grow from 5M units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, cellphones, etc. can connect via wireless protocols such as 802.11a/b/g. Several or more access points 102 can be further connected to an access point controller 104. Switch 106 can be connected to multiple access points 102, access point controllers 104, or other network wired and/or wireless elements such as switches, bridges, computers, and servers. Switch 106 can further provide an uplink to another network. Many possible alternative topologies are possible, and this figure is intended to illuminate, rather than limit, the present inventions.

Problems with security, in particular, are relevant to all possible deployments of wireless networks. Most of the security problems have been brought on by flaws in the WEP algorithm which seriously undermine the security of the system making it unacceptable as an Enterprise solution. In particular, current wireless networks are vulnerable to:
Passive attacks to decrypt traffic based on statistical analysis.
Active attack to inject new traffic from unauthorized mobile stations, based on known plaintext.
Active attacks to decrypt traffic, based on tricking the access point.
Dictionary-building attacks that, after analysis of about a day's worth of traffic, allows real-time automated decryption of all traffic.

Analysis suggests that all of these attacks can be mounted using only inexpensive off-the-shelf equipment. Anyone using an 802.11 wireless network should not therefore rely on WEP for security, and employ other security measures to protect their wireless network. In addition WLAN also has security problems that are not WEP related, such as:
Easy Access—“War drivers” have used high-gain antennas and software to log the appearance of Beacon frames and associate them with a geographic location using GPS. Short of moving into heavily shielded office space that does not allow RF signals to escape, there is no solution for this problem.
“Rogue” Access Points—Easy access to wireless LANs is coupled with easy deployment. When combined, these two characteristics can cause headaches for network administrators. Any user can run to a nearby computer store, purchase an access point, and connect it to the corporate network without authorization an thus be able to roll out their own wireless LANs without authorization.
Unauthorized Use of Service—For corporate users extending wired networks, access to wireless networks must be as tightly controlled as for the existing wired network. Strong authentication is a must before access is granted to the network.
Service and Performance Constraints—Wireless LANs have limited transmission capacity. Networks based on 802.11b have a bit rate of 11 Mbps, and networks based on the newer 802.11a technology have bit rates up to 54 Mbps. This capacity is shared between all the users associated with an access point. Due to MAC-layer overhead, the actual effective throughput tops out at roughly half of the nominal bit rate. It is not hard to imagine how local area applications might overwhelm such limited capacity, or how an attacker might launch a denial of service attack on the limited resources.
MAC Spoofing and Session Hijacking—802.11 networks do not authenticate frames. Every frame has a source address, but there is no guarantee that the station sending the frame actually put the frame “in the air.” Just as on traditional Ethernet networks, there is no protection against forgery of frame source addresses. Attackers can use spoofed frames to redirect traffic and corrupt ARP tables. At a much simpler level, attackers can observe the MAC addresses of stations in use on the network and adopt those addresses for malicious transmissions.
Traffic Analysis and Eavesdropping—802.11 provides no protection against attackers that passively observe traffic. The main risk is that 802.11 does not secure data in transit to prevent eavesdropping. Frame headers are always “in the clear” and are visible to anybody with a wireless network analyzer.

There are no enterprise-class wireless network management systems that can address all of these problems. Attempts have been made to address certain of these problems, usually on a software level.

Meanwhile, however, many WLAN vendors are integrating combined 802.11a/g/b standards into their chipsets. Such chipsets are targeted for what are called Combo-Access Points which will allow users associated with the Access Points to share 100Mbits of bandwidth in Normal Mode and up to ˜300Mbits in Turbo Mode. The table below shows why a software security solution without hardware acceleration is not feasible when bandwidth/speeds exceed 100Mbits.

| | | |
|---|---|---|
| | Required | |
| | Processor | |
| Interface | Speed [MHz] | CPU |

| | BW | | IPSec + | Subsys |
|---|---|---|---|---|
| Type | [Mbs] | IPSec | Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Current solutions also provide only limited support for switching of Internet Protocol Security Protocol (IPSec) and Layer Two Tunneling Protocol (L2TP) with IPSec traffic.

Although infrastructures for wired networks have been highly developed, the above and other problems of wireless networks are comparatively less addressed. Meanwhile, there is a need to address situations where enterprises and/or networks may have any combination of both wired and wireless components.

### SUMMARY

Embodiments of the present invention relate generally to a single-chip solution that addresses current weaknesses in wireless networks, but yet is scalable for a multitude of possible wired and wireless implementations. Current solutions to resolve/overcome the weaknesses of WLAN are only available in the form of Software or System implementations. These resolve only specific WLAN problems and they do not address all of the existing limitations of wireless networks.

In accordance with an aspect of the invention, an apparatus provides an integrated single chip solution to solve a multitude of WLAN problems, and especially Switching/Bridging, and Security. In accordance with an aspect of the invention, the apparatus is able to terminate secured tunneled IPSec and L2TP with IPSec traffic. In accordance with a further aspect of the invention, the architecture can handle both tunneled and non-tunneled traffic at line rate, and manage both types of traffic in a unified fashion. The architecture is such that it not only resolves the problems pertinent to WLAN, it is also scalable and useful for building a number of useful networking products that fulfill enterprise security and all possible combinations of wired and wireless networking needs.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

FIG. 2 is a block diagram illustrating a wired and wireless network device architecture in accordance with an embodiment of the present invention; and

FIG. 3 is a diagram illustrating the flow of IPSec packets in a network device embodiment, such as that illustrated in FIG. 2.

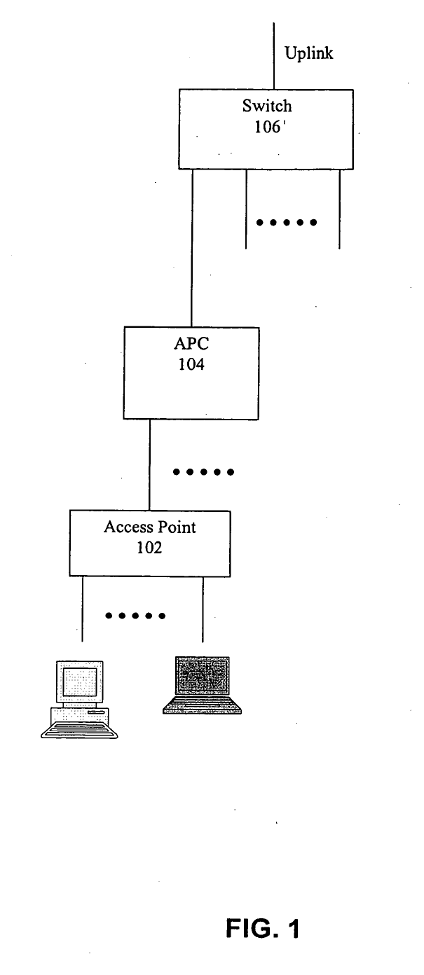

### DETAILED DESCRIPTION

For the above and other reasons, it would be desirable to deliver a single chip solution to solve wired and wireless LAN Security, including the ability to terminate a secure connection in accordance with such protocols as 802.11i, Secure Sockets Layer (SSL), Transport Layer Security (TLS), IPSec, PPTP with Microsoft Point-To-Point Encryption (MPPE) and L2TP with IPSec. Such a single chip solution should also be scalable to enable implementation in the various components and alternative topologies of wired and/or wireless networks, such as, for example, in an access point, an access point controller, or in a switch.

IPSec, short for “IP Security,” is a set of protocols developed by the IETF to support secure exchange of packets at the Internet Protocol (IP) layer. IPsec has been deployed widely to implement Virtual Private Networks (VPNs). IPsec supports two encryption modes: Transport and Tunnel. Transport mode encrypts only the data portion (payload) of each packet, but leaves the header untouched. The more secure Tunnel mode encrypts both the header and the payload. On the receiving side, an IPSec-compliant device decrypts each packet. In some IPSec embodiments, the sending and receiving devices share a public key. In some embodiments, this may be accomplished through a protocol known as Internet Security Association and Key Management Protocol/Oakley (ISAKMP/Oakley), which allows the receiver to obtain a public key and authenticate the sender using digital certificates.

L2TP, or “Layer Two Tunneling Protocol,” is an extension to the PPP protocol that enables ISPs to operate Virtual Private Networks (VPNs).

Aspects of the present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the present invention can be partially or fully implemented using known components, only those portions of such known components that are necessary for an understanding of the embodiments will be described, and detailed descriptions of other portions of such known components will be omitted so as not to obscure the invention. Still further, aspects of the present invention encompass present and future known equivalents to the known components referred to herein by way of illustration, and implementations including such equivalents are to be considered alternative embodiments of the invention.

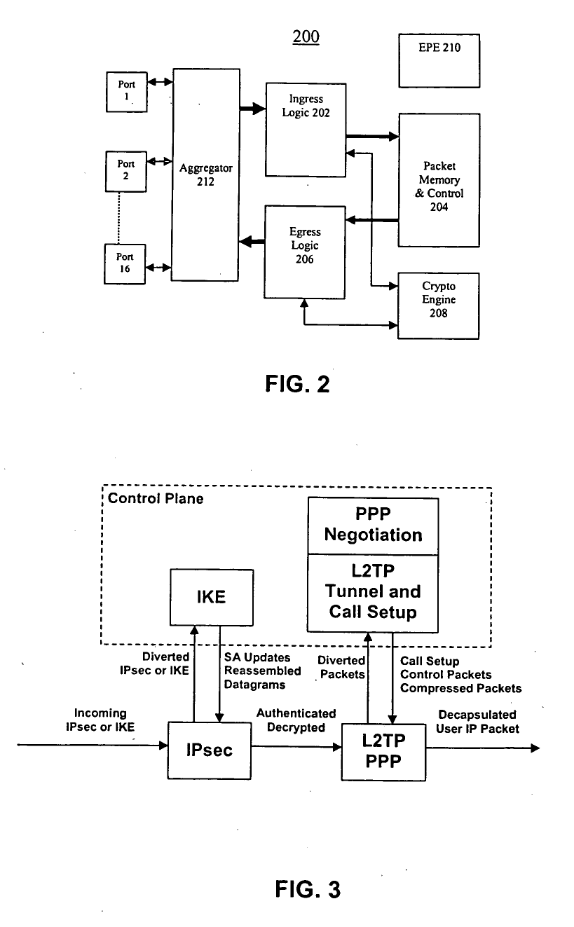

FIG. 2 is a block diagram illustrating an example implementation of a single-chip wired and wireless network device 200 that can be used to implement the features of the present invention. As shown in FIG. 2, chip 200 includes ingress logic 202, packet memory and control 204, egress logic 206, crypto engine 208, an embedded processor engine 210 and an aggregator 212. In some embodiments, crypto engine 208 may be divided into an encryptor and a separate decryptor. Encyrptor performs the encryption acts of crypto engine 208, while decryptor performs decryption acts of ecrypto engine 208. One example device 200 is described in detail in co-pending application No. ______ (Atty. Dkt. 79202-309844 (SNT-001)), the contents of which are incorporated herein by reference.

In accordance with one aspect of the invention, IPSec packets received and destined for the chip 200 are forwarded to the Crypto Engine 208 for authentication and decryption. Normally a Virtual Private Network (VPN) Session between W/LAN Client and Access Point/Switch uses the IPSec tunnel mode (transport mode can be used for network management). The Pre-parsing is done by the Ingress logic to determine the type of packet, whether it is Internet Key Exchange (IKE), IPSec, L2TP or Point-to-Point Tunneling Protocol (PPTP).

Accordingly, the Crypto Engine of the present embodiment is able to provide hardware acceleration for IKE, VPN authentication, encryption and decryption for packets destined to and tunneled packets from a wired or wireless LAN network. Of the standards for authentication, encryption and decryption device 200 will support those required for Secure Sockets Layer (SSL), Transport Layer Security (TLS), IPSec, PPTP with Microsoft Point-To-Point Encryption (MPPE) and L2TP with IPSec. For security reasons, all packets originating from and destined to W/LAN clients are tunneled using either 802.11i, IPSec VPN, L2TP, PPTP or Secure Sockets Layer (SSL). The authentication, encryption and decryption method used for tunneling is configurable and negotiated between a device 200-based peer and the WLAN client. As per tunneling standards a single policy or a policy bundle may govern packet authentication, encryption/decryption.

The Crypto Engine thus serves as the termination point for the tunnel from the W/LAN side. VPN Session between W/LAN Client and Access Point/Switch uses the tunnel mode (transport mode is used for network management). The Crypto Engine does the following: Encapsulate, Authenticate and Encrypt IPSec packet going to the W/LAN side; Authenticate and De-crypt and De-capsulate incoming IPSec packet from the W/LAN side; and L2TP/IPSec, PPTP packet encryption/decryption support for Microsoft clients, 802.11i, SSL processing.

The Embedded Processing Engine (EPE) 210 enables fast path processing of certain types of packets that are difficult to handle in hardware. This CPU can also be used for Control Path processing and implementing the functions of the Host CPU for the applications that are cost sensitive. The Fast Path functionality implemented by the EPE includes packet processing for SSL, PPTP and L2TP protocol. The Host CPU functions that can be done using the EPE include processing of all Control packets, processing of Spanning Tree Protocol and other L2 protocols such as GARP Multicast Registration Protocol (GMRP), GARP VLAN Registration Protocol (GVRP), Virtual LAN (VLAN) processing etc., TCP/IP stack, other applications such as telnet, Trivial File Transfer Protocol (TFTP), ping, Dynamic Host Configuration Protocol (DHCP), etc., IPSec Protocol stack, and PPTP and L2TP Control messages, SSL termination.

The processing of IPSec and L2TP with IPSec packets will now be described in more detail according to one possible example implementation of the present invention.

IPSec Packet Inbound Processing

Inbound IPSec Packet processing will address scenarios when a wireless client originates traffic destined for the LAN/wired side of the network. The following possibilities are to be assumed for the WLAN client.
1. All traffic between a WLAN Client and the device 200 is tunneled using any one of an IPSec, L2TP tunnel for total data protection.
2. The Inbound packet then undergoes the following processing for IPSec and L2TP with IPSec:
   a) Outer L2 header is ignored.
   b) If the more fragment (MF) bit is set in the L3 Header wait until a fragment arrives with MF bit not set. The CPU reassembles the packet before commencement of crypto processing.
   c) If anti-replay is enabled, it uses the anti-replay window in the Security Association (SA) to determine if the packet is a replay. Perform anti-replay—Else ignore.
   d) SA lookup—It uses the SA found in Incoming SA table to Authenticate and Decrypt the incoming packet. For incoming packets the SA table lookup key may comprise the IPSec protocol (Encapsulating Security Payload/Authentication Header) and the SPI in the AH/ESP Header. The lookup table is Incoming SA table. If the lookup fails, the packet is dropped and sent to CPU for logging. The log data SHOULD include the SPI value, date/time received, Source Address, Destination Address, the Sequence Number.
   e) Authenticate data.
   f) Decrypt the packet This is done with the understanding that “no confidentiality” is offered by using the NULL encryption algorithm.
      In certain cases, the erroneous result of the decryption operation (an invalid IP datagram or transport-layer frame) will not necessarily be detected by IPSec, and is the responsibility of later protocol processing.
   g) Do a selector match of packet source address from inner IP header. If match fails drop and send to CPU to log event.
   h) Internet Control Message Protocol (ICMP) Query messages are end-to-end and such packets undergo normal SA based IPSec processing.
   i) ICMP Error messages generated by end hosts (WLAN Clients) also undergo normal Security Association (SA) based IPSec processing.
      L2TP Input Processing

The requirement for L2TP over IPsec derives from a need to support Microsoft IPsec VPN clients. Microsoft uses L2TP to encapsulate client IP packets in order to create remote access VPN tunnels, and secures L2TP using IPsec according to RFC3193. This is the only way Microsoft supports dynamic addressed remote access IPsec clients. Microsoft supports this capability in all current versions of Windows, including Windows 2000, XP, 98, NT4.0, and ME.

FIG. 3 illustrates the flow for incoming traffic.

IPSec Outgoing Tunneling Processing

Outbound IPSec Packet processing will address scenarios when traffic from the wired network side tunnels traffic to a wireless client. If the IPSec SA lookup fails, the packet is dropped and counter incremented.
a) SA exists—match on Destination IP Address. If entry is found then get SPI and protocol from the outgoing SA entry.

a. Create Outer IP Header with

How Outer Hdr Relates to Inner Hdr

| IPv4 | Outer Hdr at | Inner Hdr at |
|---|---|---|
| Header fields: | Encapsulator | Decapsulator |
| version | 4 (1) | no change |
| header length | constructed | no change |
| TOS | copied from inner hdr (5) | no change |
| total length | constructed | no change |
| ID | constructed | no change |
| flags (DF, MF) | constructed, DF (4) | no change |
| fragmt offset | constructed | no change |

b. Create IPSec ESP Header
c. Encapsulate the entire original IP datagram.
d. Enter the Security Parameter Index (SPI)—An arbitrary 32-bit number, chosen by the recipient, that identifies the group of security protocols and parameters used by the sender. This group is called a security association (SA). This is obtained from the SA.
e. Enter the Sequence number—Provides anti-replay support to the ESP. The sender inserts this unique, monotonically increasing number into the header. The sequence number enables the identification of a packet as a duplicate; these packets are dropped, without the expense involved in encryption. New sessions may start with 0.
f. Add necessary padding. Several factors require or motivate use of the Padding field.
g. Encrypt the result (Payload Data, Padding, Pad Length, and Next Header) using the key, encryption algorithm, algorithm mode indicated by the SA and cryptographic synchronization data (if any).
h. If authentication is required, perform encryption first, before the authentication, and the encryption should not encompass the Authentication Data field.
i. Compute Integrity Check Value (ICV) using all fields except the authentication data field. This field is used to store the ICV value.
j. The remaining segments of ESP are encrypted and authenticated during transmission.
   L2TP Fast Path Implementation

The implementation approach for L2TP can be summarized as:
Control messages are handled by the control plane CPU. This has been described in the previous section.
Data messages are handled in the fast path once the data session is established.
Compression, including header compression, is done in the control plane.

In other words, handle the 98% case in hardware (no sequence numbers, no compression, Perfect Forwarding Check (PFC) and ACFC), and the rest in software.

Control CPU Interaction

The L2TP component needs to send unsolicited decrypted packets to the control processor. These would be for
Control packets for L2TP and PPP negotiation
Control packets for L2TP connection termination
Compression or other processing requirements (e.g., to fully conform with the protocol but not necessarily with optimal performance)
   Outgoing

Outgoing state is very similar to incoming, and shown in the following table. The following fields are part of the Egress SA Table.

| | | | Size | Default |
|---|---|---|---|---|
| Field | Description | Name | (bits) | Value |
| L2TP | Do L2TP encapsulation | L2TPENA | 1 | 0 |
| Enabled | | | | |
| Established | Enable fast path | L2TPEST | 1 | 0 |
| | processing | | | |
| Compression | Perform compression | L2TPCOMPC | 1 | 0 |
| Packet Count | Number of user packets | L2TPTPKTS | 64 | 0 |
| | sent | | | |
| Byte Count | Number of user bytes | L2TPTBYTES | 64 | 0 |
| | sent | | | |
| Tunnel ID | Tunnel ID for building | L2TPTUNID | 16 | 0 |
| | header | | | |
| Call ID | Call ID for building | L2TPCALLID | 16 | 0 |
| | header | | | |

If L2TP processing is needed, and the connection is in the Established state, the L2TP header component is built and added at the start of the packet prior to building the ESP transport mode header. The processing steps are:
Increment the packet count, add the length to the byte count. Note that packets from the control processor are not counted as tunnel user data.
If compression if needed, send to control processor, treat the same as a control message when it comes back.
Outgoing packets received from the control processor must include the L2TP and PPP headers. For normal user packets:
   Prepend the PPP protocol byte 0×21 (assume PFC and ACFC in effect).
   Build and prepend the L2TP header (assume no sequence numbers)
      Fixed first 16 bit word (0×4002)
      Total length, including header
      Tunnel ID
      Call ID
Perform IPsec encapsulation:
   ESP header (SPI, serial number)
   IV (randomly generated)
   Pad according to IPsec requirements (pad bytes incrementing from 1)
   ESP trailer next protocol is UDP (17), followed by the pad length
   Encrypt
   Append 12 byte HMAC

An example of a Security Association table that can be used by the ingress path logic according to the present invention is provided below:

| | | | Size | Default |
|---|---|---|---|---|
| Field | Description | Name | (# of bits) | Value |
| spi | Security Parameter Index - This is | Spi | 32 | 0 |
| | a 32 bit integer used with IP | | | |
| | Address of destination and Ipsec | | | |
| | Protocol to match traffic to an SA. | | | |
| | 0 - This value implies entry is | | | |
| | invalid. | | | |
| Valid | Valid bit | Valid | 1 | |
| softTimerExpired | Soft Timer Expired bit | softTimerExpired | 1 | |
| authentkey | Key used for HMAC. MD5 - 256 | authentkey | 320 | |
| | and SHA1 - 320 | | | |
| key | Key used by DES, TDES and AES | key | 256 | |
| | DES/TDES - 64 | | | |
| | AES - 128, 192, 256 | | | |
| keyLength | Length of AES key. | keyLength | 2 | |
| | 0 - 128 bits | | | |
| | 1 - 192 bits | | | |
| | 2 - 256 bits | | | |
| | 3 - reserved | | | |
| authentAlgo | Authentication Algorithm | authentAlgo | 2 | |
| | 0 - MD5 | | | |
| | 1 - SHA1 | | | |
| | 2 - HMAC MD5 | | | |
| | 3 - HMAC SHA1 | | | |
| encryptAlgo | Encryption Algorithm | encrptAlgo | 2 | |
| | 0 - DES | | | |
| | 1 - TDES | | | |
| | 2 - AES | | | |
| | 3 - Null | | | |
| | If 3 ignore authentication | | | |
| | Algorithm | | | |
| encryptMode | Encryption Mode | encryptMode | 2 | |
| | 0 - CBC (DES, TDES) | | | |
| | 1 - CTR (DES, TDES, AES) | | | |
| | 2 - CCM (AES) | | | |
| | 3 - XCBC (AES) | | | |
| pktType | Type of packet | pktType | 1 | |
| | 0 - Tunnel (IPSec) | | | |
| | 1 - Transport (L2TP) | | | |
| sendToCpu | If this bit is set send packet to | sendToCpu | 1 | |
| | CPU | | | |
| ipSA | Source IP Address required to | ipSA | 32 | |
| | validate packet after decryption. | | | |
| replayCheck | If this bit is set perform replay | replayCheck | 1 | |
| | check | | | |
| seqNum | A 32-bit counter incremented by 1 | seqNum | 64 | 0 |
| | for every packet. | | | |
| seqNumBitmap | To prevent repetitions of old | seqNumBitmap | 64 | 0 |
| | packets. | | | |
| byteCount | Number of clear packet received | byteCount | 32 | |
| | on SA | | | |
| pktCount | Number of clear packets received | pktCount | 32 | |
| | on SA | | | |

An example of a Security Association Table that can be used by the egress path logic in accordance with the present invention is provided below:

| | | | Size | Default |
|---|---|---|---|---|
| Field | Description | Name | (# of bits) | Value |
| inIPDA | Inner Destination IP Address | inIPDA | 32 | |
| seqNum | A 32-bit counter incremented by 1 | seqNum | 64 | 0 |
| | for every packet. | | | |
| byteCount | Number of clear packet received | byteCount | 32 | |
| | on SA | | | |
| pktCount | Number of clear packets received | pktCount | 32 | |
| | on SA | | | |
| Valid | Valid bit | Valid | 1 | |
| softTimerExpired | Soft Timer Expired bit | softTimerExpired | 1 | |
| spi | Security Parameter Index - This is | Spi | 32 | 0 |
| | a 32 bit integer used with IP | | | |
| | Address of destination and Ipsec | | | |
| | Protocol to match traffic to an SA. | | | |
| | 0 - This value implies entry is | | | |
| | invalid. | | | |
| authentkey | Key used for HMAC. MD5 - 256 | authentkey | 320 | |
| | and SHA1 - 320 | | | |
| key | Key used by DES, TDES and AES | Key | 256 | |
| | DES/TDES - 64 | | | |
| | AES - 128, 192, 256 | | | |
| outIPDA | Outer IP Destination Address | outIPDA | 32 | |
| tunnelID | L2TP Tunnel ID | tunnelID | 16 | |
| callID | L2TP Call ID | called | 16 | |
| keyLength | Length of AES key. | keyLength | 2 | |
| | 0 - 128 bits | | | |
| | 1 - 192 bits | | | |
| | 2 - 256 bits | | | |
| | 3 - reserved | | | |
| authentAlgo | Authentication Algorithm | authentAlgo | 2 | |
| | 0 - MD5 | | | |
| | 1 - SHA1 | | | |
| | 2 - HMAC MD5 | | | |
| | 3 - HMAC SHA1 | | | |
| encryptAlgo | Encryption Algorithm | encrptAlgo | 2 | |
| | 0 - DES | | | |
| | 1 - TDES | | | |
| | 2 - AES | | | |
| | 3 - Null | | | |
| | If 3 ignore authentication | | | |
| | Algorithm | | | |
| encryptMode | Encryption Mode | encryptMode | 2 | |
| | 0 - CBC (DES, TDES) | | | |
| | 1 - CTR (DES, TDES, AES) | | | |
| | 2 - CCM (AES) | | | |
| | 3 - XCBC (AES) | | | |
| pktType | Type of packet | pktType | 1 | |
| | 0 - Tunnel (IPSec) | | | |
| | 1 - Transport (L2TP) | | | |
| sendToCpu | If this bit is set send packet to | sendToCpu | 1 | |
| | CPU | | | |

Although the present invention has been particularly described with reference to the embodiments herein, it should be readily apparent to those of ordinary skill in the art that changes and modifications in the form and details may be made without departing from the spirit and scope of the invention. It is intended that the appended claims include such changes and modifications.

1. An apparatus to secure network traffic in a wired and/or wireless network comprising:
an aggregator configured to receive packets from ports;
a scalable ingress path configured to receive the packets from the aggregator, configured to determine whether the packets are part of a secure packet tunnel;
a decryptor configured to terminate the secure packet tunnel;
an encryptor configured to originate the secure packet tunnel;
a scalable egress path configured to receive a stream of packets from the encryptor, and configured to output packet data to the aggregator;
wherein the aggregator is further configured to output the output packet data to the ports.

2. The apparatus of claim 1 wherein the aggregator receives Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packets.

3. A method of receiving an inbound packet originated by a wireless client to a wired network via an access point, comprising:
authenticating the wireless client;
associating the wireless client with the access point;
determining if the inbound packet requires security processing;
processing the inbound packet when the inbound packet requires security processing.

4. The method of claim 3, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

5. The method of claim 4, the processing of the inbound packet further comprising:
looking up a Security Association (SA) in an Incoming Security Association table to authenticate or decrypt the inbound packet.

6. The method of 5, wherein the Incoming Security Association table includes a lookup key comprising the Internet Protocol Security in an authentication header.

7. The method of 6, further comprising:
dropping the inbound packet if the look up fails.

8. The method of 7, further comprising:
logging the dropped inbound packet if the lookup fails.

9. The method of 8, further comprising:
authenticating data within the inbound packet if the look up succeeds.

10. The method of 9, further comprising:
decrypting data within the inbound packet if the look up succeeds.

11. A computer-readable medium, encoded with data and instructions of receiving an inbound packet originated by a wireless client to a wired network via an access point, when read by a computer causes the computer to:
authenticate the wireless client;
associate the wireless client with the access point;
determine if the inbound packet requires security processing;
process the inbound packet when the inbound packet requires security processing.

12. The computer-readable medium of claim 11, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

13. The computer-readable medium of claim 12, the processing of the inbound packet further comprising:
looking up a Security Association (SA) in an Incoming Security Association table to authenticate or decrypt the inbound packet.

14. The computer-readable medium of 5, wherein the Incoming Security Association table includes a lookup key comprising the Internet Protocol Security in an authentication header.

15. The computer-readable medium of 14, further encoded with instructions comprising:
dropping the inbound packet if the look up fails.

16. The computer-readable medium of 15, further encoded with instructions comprising:
logging the dropped inbound packet if the lookup fails.

17. The computer-readable medium of 16, further encoded with instructions comprising:
authenticating data within the inbound packet if the look up succeeds.

18. The computer-readable medium of 17, further encoded with instructions comprising:
decrypting data within the inbound packet if the look up succeeds.

19. An apparatus of receiving an inbound packet originated by a wireless client to a wired network via an access point, comprising:
means for authenticating the wireless client;
means for associating the wireless client with the access point;
means for determining if the inbound packet requires security processing;
means for processing the inbound packet when the inbound packet requires security processing.

20. The apparatus of claim 19, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

21. The apparatus of claim 20, the processing of the inbound packet further comprising:
means for looking up a Security Association (SA) in an Incoming Security Association table to authenticate or decrypt the inbound packet.

22. The apparatus of 21, wherein the Incoming Security Association table includes a lookup key comprising the Internet Protocol Security in an authentication header.

23. The apparatus of 22, further comprising:
means for dropping the inbound packet if the look up fails.

24. The apparatus of 23, further comprising:
means for logging the dropped inbound packet if the lookup fails.

25. The apparatus of 24, further comprising:
means for authenticating data within the inbound packet if the look up succeeds.

26. The apparatus of 25, further comprising:
means for decrypting data within the inbound packet if the look up succeeds.

27. An apparatus of receiving an inbound packet originated by a wireless client to a wired network via an access point, comprising:
a decryptor configured to authenticate the wireless client, configured to associate the wireless client with the access point, configured to determine if the inbound packet requires security processing, and configured to process the inbound packet when the inbound packet requires security processing.

28. The apparatus of claim 27, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

29. The apparatus of claim 28, wherein the decryptor is further configured to look up a Security Association (SA) in an Incoming Security Association table to authenticate or decrypt the inbound packet.

30. The apparatus of 29, wherein the Incoming Security Association table includes a lookup key comprising the Internet Protocol Security in an authentication header.

31. The apparatus of 30, wherein the decryptor is further configured to drop the inbound packet if the look up fails.

32. The apparatus of 31, wherein the decryptor is further configured to log the dropped inbound packet if the lookup fails.

33. The apparatus of 32, wherein the decryptor is further configured to authenticate data within the inbound packet if the look up succeeds.

34. The apparatus of 33, wherein the decryptor is further configured to decrypt data within the inbound packet if the look up succeeds.
